(19) United States
(12) Patent Application Publication
(10) Pub. No.: US 2024/0333993 A1
(43) Pub. Date: Oct. 3, 2024

(54) SMART ADVERTISING TIMING IN VIDEO STREAMING FROM INTERNET OF THINGS (IoT) SENSORS

(71) Applicant: INTERNATIONAL BUSINESS MACHINES CORPORATION, Armonk, NY (US)

(72) Inventors: Su Liu, Austin, TX (US); Zhan Peng Huo, Beijing (CN); Hamid Majdabadi, OTTAWA (CA); Peng Hui Jiang, Beijing (CN)

(21) Appl. No.: 18/128,500

(22) Filed: Mar. 30, 2023

(51) Int. Cl. H04N 21/262; H04N 21/4223; H04N 21/442; H04N 21/45

(52) U.S. Cl. CPC H04N 21/26241; H04N 21/4223; H04N 21/44218; H04N 21/4532

(57) ABSTRACT

Aspects of the present disclosure relate generally to presenting advertisements on a device and, more particularly, to managing the timing and duration for presenting advertisements in streaming video from activities detected by IoT sensors. For example, a computer-implemented method includes: receiving, by a processor set, an opt-in from a user; in response to the opt-in, detecting, by the processor set and via an Internet of Things (IoT) sensor, activities of the user watching a streaming video on a client device; determining, by the processor set, an advertisement tolerance level of the user based on the detected activities of the user watching the streaming video; determining, by the processor set, an optimal advertisement interval in the streaming video based on the advertisement tolerance level of the user; and streaming, by the processor set, advertisements during the optimal advertising interval in the streaming video on the client device.

### BACKGROUND

Aspects of the present invention relate generally to presenting advertisements on a device and, more particularly, to systems, computer program products, and methods of managing the timing and duration for presenting advertisements in streaming video from activities detected by IoT sensors.

There are many video streaming services available that offer video streaming to users for free. These video streaming services play video advertisements within video content to users, and revenue is generated through advertising as a revenue model. Over-the-top (OTT) ads are the advertisements delivered to viewers within video content and provide an opportunity for advertisers to reach new audiences at scale as more viewers choose streaming video content in lieu of traditional cable and broadcast TV. Instead of being tied to the program schedule of traditional cable and broadcast TV, the convenience, ease and flexibility of video streaming services to watch what a user wants and when the user wants to watch is incomparable. Video streaming services are available anytime and anywhere that a smartphone or other Internet-enabled device can connect to the Internet.

### SUMMARY

In a first aspect of the invention, there is a computer-implemented method including: receiving, by a processor set, an opt-in from a user; in response to the opt-in, detecting, by the processor set and via an Internet of Things (IoT) sensor, activities of the user watching a streaming video on a client device; determining, by the processor set, an advertisement tolerance level of the user based on the detected activities of the user watching the streaming video; determining, by the processor set, an optimal advertisement interval in the streaming video based on the advertisement tolerance level of the user; and streaming, by the processor set, advertisements during the optimal advertising interval in the streaming video on the client device.

In another aspect of the invention, there is a computer program product including one or more computer readable storage media having program instructions collectively stored on the one or more computer readable storage media. The program instructions are executable to: receive an opt-in from a user; in response to the opt-in, detect, via an Internet of Things (IoT) sensor, activities of the user watching a streaming video on a client device; analyze attention points of the user on a screen of the client device; determine an advertisement tolerance level of the user based on the analysis of the attention points of the user on the screen of the client device; determine an optimal advertisement interval in the streaming video based on the advertisement tolerance level of the user; and stream advertisements during the optimal advertising interval in the streaming video on the client device.

In another aspect of the invention, there is a system including a processor set, one or more computer readable storage media, and program instructions collectively stored on the one or more computer readable storage media. The program instructions are executable to: receive an opt-in from a user; in response to the opt-in, detect activities of the user watching a streaming video on a client device via at least one Internet of Things (IoT) sensor; predict a next activity of the user watching the streaming video based on the activities; determine an advertisement tolerance level of the user based on the predicted next activity of the user watching the streaming video; determine an optimal advertisement interval in the streaming video based on the advertisement tolerance level of the user; and stream advertisements during the optimal advertising interval in the streaming video on the client device.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 depicts an illustration of an exemplary process flow in a depiction of an exemplary physical environment in accordance with aspects of the present invention.

FIG. 4 depicts an illustration of an exemplary data table in accordance with aspects of the present invention.

FIG. 5 shows a flowchart of an exemplary method in accordance with aspects of the present invention.

FIG. 6 shows a flowchart of an exemplary method in accordance with aspects of the present invention.

### DETAILED DESCRIPTION

Aspects of the present invention relate generally to presenting advertisements on a device and, more particularly, to systems, computer program products, and methods of managing the timing and duration for presenting advertisements in streaming video from activities detected by IoT sensors. More specifically, aspects of the present invention relate to methods, computer program products, and systems for detecting, via IoT sensors, the activities of a user watching streaming video on a client device, determining an advertisement tolerance level of the user for interrupting streaming the content of the video to show advertisements, determining an optimal advertisement interval in the streaming video to show the advertisements, and streaming advertisements during the optimal advertising interval in the streaming video on the client device. Aspects of the present invention dynamically maximize advertisement time in streaming video based on user tolerance in real time and manage the advertisement insertion time and advertisement length based on user activities detected by IoT sensors.

In embodiments, the methods, systems, and program products described herein detect, via IoT sensors, activities of a user watching a streaming video on a client device and determine an advertisement tolerance level of the user based on the detected activities of the user watching the streaming video. The activities may include in embodiments, for instance, watching the streaming video, sleeping, opening an email application, making coffee, among other activities. The IoT sensors may be any type of sensor for any use including, for example, a proximity sensor used in appliances, for instance, to detect an open door, a motion sensor used in security systems, for instance, to detect the presence and motion of a person, a wearable sensor such as an accelerometer to detect movement, sleep and other user activities, a camera to detect eye gazing and/or eye movement, among other types and uses of IoT sensors. Such IoT sensors may detect user activities while the user is watching the streaming video.

The methods, systems, and computer program products further determine an advertisement tolerance level of the user based on the analysis of the activities of the user watching the streaming video, determine an optimal advertisement interval in the streaming video based on the advertisement tolerance level of the user, and stream advertisements during the optimal advertising interval in the streaming video on the client device. The advertisement tolerance level of the user may be based in embodiments on the activities of the user watching the streaming video detected by various IoT sensors and/or the likelihood that the user intends to continue watching the streaming video and/or the predicted next activity of the user. The likelihood that the user intends to continue watching the streaming video may be based in embodiments on the number of attention points of the user on the screen of the client device which can be detected by an integrated camera. The higher the number of attention points of the user on the screen over a certain time period indicates the greater the likelihood the user intends to continue watching the video stream.

Aspects of the present invention are directed to improvements in computer-related technology and change the way computers operate in managing the timing and duration for presenting advertisements in streaming video from activities detected by IoT sensors, among other features as described herein. In embodiments, the methods, computer program products, and systems may comprise detecting, via IoT sensors, the activities of the user watching streaming video on the client device, determining an advertisement tolerance level of the user based on the detected activities of the user watching the streaming video, determining an optimal advertisement interval in the streaming video based on the advertisement tolerance level of the user, and streaming the advertisements during the optimal advertising interval in the streaming video on the client device. Advantageously, the methods, computer program products, and systems described herein dynamically maximize advertisement time in streaming video based on user tolerance in real time. Furthermore, the methods, systems, and computer program products described herein manage and control the advertisement insertion time and advertisement length in streaming video based on user activities detected by IoT sensors. These are specific improvements in the way computers may operate and interoperate for managing the timing and duration for presenting advertisements in streaming video.

Implementations of the disclosure describe additional elements that are specific improvements in the way computers may operate and these additional elements provide non-abstract improvements to computer functionality and capabilities. As an example, the methods, computer program products, and systems describe SAT activity detector module, attention point identifier module, watching intention analyzer module, activity predictor module, ads tolerance wizard module, SAT calculator module, IoT sensors, SAT manager module, SAT ads selector module, and SAT ads inserter module that detect, via IoT sensors, the activities of the user watching streaming video on the client device, determine an advertisement tolerance level of the user based on the detected activities of the user watching the streaming video, determine an optimal advertisement interval in the streaming video based on the advertisement tolerance level of the user, and stream the advertisements during the optimal advertising interval in the streaming video on the client device. The additional elements of the methods, computer program products, and systems of the present invention are specific improvements in the way computers may operate and interoperate to manage the timing and duration for presenting advertisements in streaming video.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as smart advertising timing in video streaming via IoT sensors code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

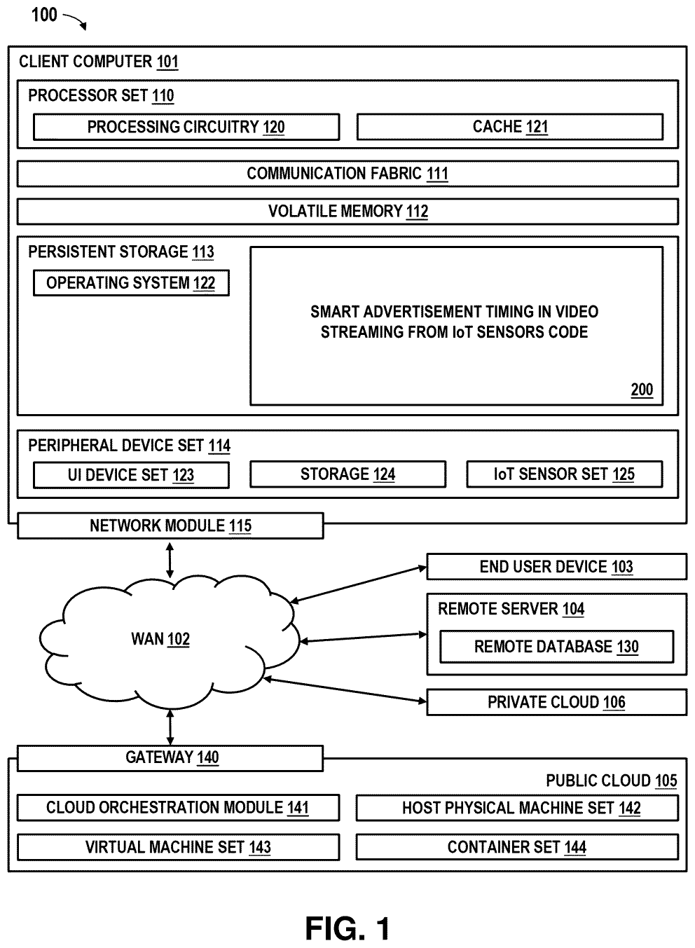

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

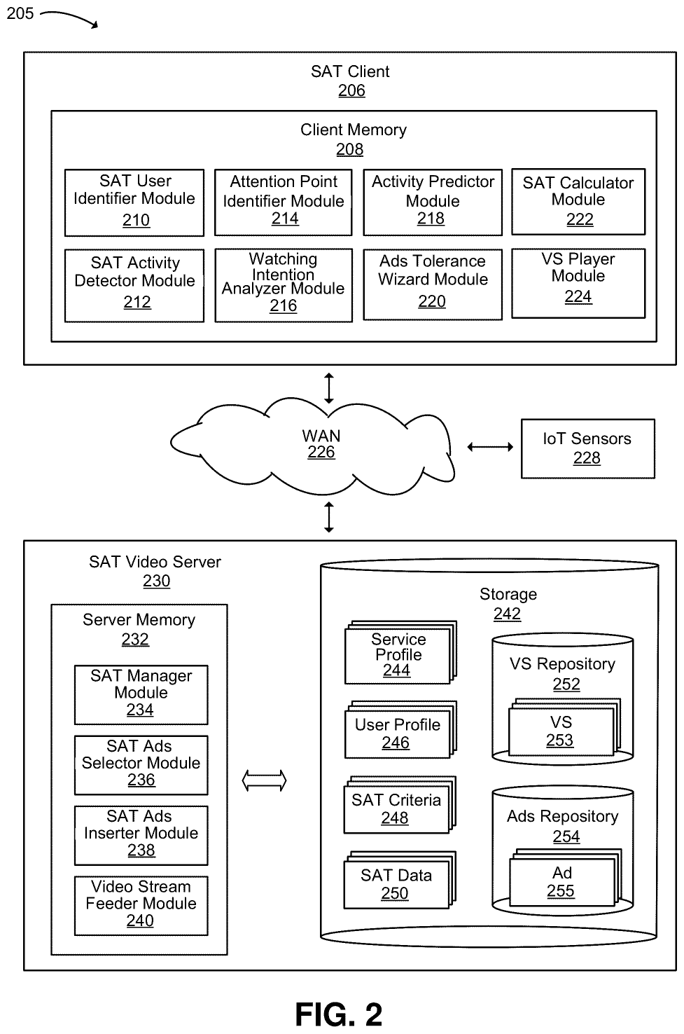

FIG. 2 shows a block diagram of an exemplary environment 205 in accordance with aspects of the present invention. In embodiments, the environment includes a SAT client 206 which may be a computer system such as end user device 103, described with respect to FIG. 1, with which computer 101 may communicate via network module 115 through WAN 102, each also described with respect to FIG. 1. In general, SAT client 206 receives and plays streamed video content and includes functionality for determining an optimal advertising interval from user activities detected by IoT sensors.

SAT client 206 has client memory 208 such as volatile memory 112 described with respect to FIG. 1. SAT client 206 includes, in client memory 208, SAT user identifier module 210 having functionality to provide an identifier of the user of the SAT client 206, SAT activity detector module 212 having functionality to detect the activity of the user, attention point identifier module 214 having functionality to identify the attention point of the user, watching intention analyzer module 216 having functionality to determine the likelihood the user intends to continue watching the video stream, activity predictor module 218 having functionality to predict the next activity of the user, ads tolerance wizard module 220 having functionality to determine the advertisement tolerance level of the user for interrupting streaming the content of the video to show ads, SAT calculator module 222 having functionality to determine the optimal advertisement interval to show ads inserted into the video stream, and video stream (VS) player module 224 having functionality to receive and play video streams.

In embodiments, the SAT activity detector module 212 includes functionality to detect activities of a user watching the video stream via various IoT sensors. For example, the SAT client 206 may be a smart device with a camera such as a smart TV that includes eye gazing and/or eye tracking functionality that detects the user watching the video stream or sleeping. The SAT activity detector module 212 may receive information of eye gazing and/or eye tracking of the user watching the video stream or sleeping. As another example, the SAT activity detector module 212 may receive information from the user's smart phone with a camera that includes eye gazing and/or eye tracking functionality that detects the user looking at the smart phone screen. The SAT activity detector module 212 may also receive information of applications in use by the user from the user's smart phone such as an email application, an application controlling a coffee maker, an Internet browser, or other applications. The SAT activity detector module 212 may further receive information from IoT sensors of smart appliances of activities such as information from a proximity sensor of the opening and closing of the user's refrigerator door. Those skilled in the art should appreciate that other IoT sensors may provide information of the user's activities to the SAT activity detector module 212 including wearable IoT sensors such as wireless insole pressure sensors and accelerometer sensors that transmit information of the user's motion, among other IoT sensors.

In embodiments, the attention point identifier module 214 includes functionality to receive information to identify the attention point of the user from IoT sensors such as a camera. For instance, the SAT client 206 may be a smart TV in embodiments with a camera that includes eye gazing and/or eye tracking functionality that detects the user's visual attention, including watching the video stream, sleeping, looking away from the video stream, or being absent from view of the camera. The attention point identifier module 214 may receive information of 60 to 300 attention points per minute in embodiments that may be analyzed to understand the level of visual attention by the user watching the video stream.

In embodiments, the watching intention analyzer module 216 includes functionality to determine the likelihood the user intends to continue watching the video stream based on the number of attention points of the user on the screen detected by IoT sensors for the most recent time period, for instance the past minute. The higher the number of attention points of the user on the screen over the time period indicates the greater visual attention of the user watching the video stream and the greater the likelihood the user intends to continue watching the video stream. The watching intention analyzer module 216 provides a watching intention likelihood that may be a percentage on a scale of 0 to 100 of the watching attention of the user watching the video stream for a certain time period in embodiments.

In embodiments, the activity predictor module 218 includes functionality to receive the activities of the user watching the video stream detected by various IoT sensors, such as watching the video stream, sleeping, making coffee, opening the refrigerator door, interacting with email, among other activities, and the watching intention likelihood for a predetermined number of past time periods and predicts the activities of one or more upcoming time periods. For instance, the activity predictor module 218 may receive the activity of watching the video steam and the watching intention likelihood of 90 percent for the previous time period of a minute in embodiments and predict the activity of the user will be watching the video stream for the current time period. As another example, the activity predictor module 218 may receive the activities of watching the video steam and opening an email application and the watching intention likelihood of 50 percent for the previous time period of a minute in embodiments and predict the activity of the user will be checking email for the current time period and the next two upcoming time periods, for instance for the next three (3) minutes. The predicted activity may be used among other information to determine the advertisement tolerance level of the user for interrupting streaming the content of the video to show ads inserted into the video stream for upcoming time periods in embodiments.

In embodiments, the ads tolerance wizard module 220 includes functionality to determine the advertisement tolerance level of the user for interrupting streaming the content of the video to show ads inserted into the video stream for upcoming time periods. To do so, the ads tolerance wizard module 220 receives the activities of the user watching the video stream detected by various IoT sensors and the watching intention likelihood for a predetermined number of past time periods as well as the predicted activities of certain upcoming time periods in embodiments and determines the advertisement tolerance level of the user for interrupting streaming the content of the video to show ads inserted into the video stream. The advertisement tolerance level may be represented as a percentage on a scale of 0 to 100 for a certain time period in embodiments. For instance, the ads tolerance wizard module 220 may receive the activity of watching the video steam and the watching intention likelihood of 90 percent for the previous time period of a minute in embodiments as well as the predicted activity of the user to be watching the video stream for the upcoming time period and determines the advertisement tolerance level for interrupting streaming the content of the video to be 10 percent for the upcoming time period. As another example, the ads tolerance wizard module 220 may receive the activities of watching the video steam and opening an email application and the watching intention likelihood of 50 percent for the previous time period of a minute in embodiments as well as the predicted activity of the user to be checking email for the next three upcoming time periods, for instance for the next three (3) minutes, and determines the advertisement tolerance level for interrupting streaming the content of the video to be 50 percent for the upcoming three (3) time periods. The advertisement tolerance level for interrupting streaming the content of the video for upcoming time periods may be used among other information to determine the optimal advertisement interval to show ads inserted into the video stream in embodiments.

In embodiments, the SAT calculator module 222 includes functionality to receive the information of the advertisement tolerance level for upcoming time periods and determine the optimal advertisement interval for showing ads inserted into the video stream. The optimal advertisement interval for showing ads inserted into the video stream may be represented as a tuple of a start time, t1, and an end time, t2, such as (t1, t2) in embodiments. In the example of the user's activities of watching the video stream and making coffee, the watching intention likelihood may be 50 percent for the previous time period and the predicted activity may be not watching the video stream for the next ten (10) upcoming time periods while the user is taking a coffee break. In this example, the SAT calculator module 222 may receive information of an advertisement tolerance level of 100 for the next ten (10) upcoming time periods of a minute in embodiments and determine an optimal advertisement interval of ten (10) minutes beginning at the start of the next upcoming time period and ending at the end of the tenth (10th) upcoming time period. The SAT client sends the optimal advertisement interval for showing ads inserted into the video stream determined by the SAT calculator module 222 to the SAT video server 230 which selects and inserts ads in the video stream for the optimal advertisement interval. In addition to the information of the advertisement tolerance level for upcoming time periods, those skilled in the art should appreciate that the SAT calculator module 222 may also include functionality to receive in embodiments the activities of the user watching the video stream detected by various IoT sensors, the watching intention likelihood for a predetermined number of past time periods, and the predicted activities of certain upcoming time periods for use in determining the optimal advertisement interval.

In embodiments, the VS player module 224 may be any video streaming player that includes functionality to receive and play video streams on the SAT client 206 and that supports OTT advertisements, including HTML compatible video streaming players such as an HTML5 compatible video streaming player or other video streaming player. The VS player module 224 includes functionality in embodiments to receive and decode streaming video data from the video stream feeder module 240 in server memory 232 of the SAT video server 230.

In embodiments, SAT user identifier module 210, SAT activity detector module 212, attention point identifier module 214, watching intention analyzer module 216, activity predictor module 218, ads tolerance wizard module 220, SAT calculator module 222, and video stream (VS) player module 224, each may include routines, programs, objects, components, logic, data structures, and so on that perform particular tasks or implement particular data types used to carry out the functions and/or methodologies of embodiments of the invention as described herein. These modules are executable by the processing circuitry to perform the inventive methods as described herein. The SAT client 206 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, environment 205 of FIG. 2 also includes IoT sensors 228 which may communicate with SAT client 206 over WAN 226, which may be a WAN such as WAN 102 described with respect to FIG. 1. The IoT sensors 228 may be any type of sensor for any use including, for example, a proximity sensor used in appliances, for instance, to detect an open door, a motion sensor used in security systems, for instance, to detect the presence and motion of a person, a wearable sensor such as an accelerometer to detect movement, sleep and other user activities, a camera to detect eye gazing and/or eye movement, among other types and uses of IoT sensors. Such IoT sensors may detect user activities while the user is watching a video stream and may communicate with SAT client 206 over WAN 226 or a wireless network. In embodiments, detecting user activities by IoT sensors is performed after the user has opted-in and consented to the system detecting the user's activities. Furthermore, storage and use of the user's activities detected are in an appropriately secure manner reflective of the type of information, for example, through various encryption and anonymization techniques for particularly sensitive information.

In accordance with aspects of the invention, environment 205 of FIG. 2 also includes a smart advertisement server (SAT) video server 230, which may be a computer system such as a computer 101 described with respect to FIG. 1 with which end user devices 103 and remote servers 104, each also described with respect to FIG. 1, may communicate over a network such as WAN 102 described with respect to FIG. 1. In general, SAT video server 230 supports services for video streaming and OTT advertising to users' client VS players.

SAT video server 230 has server memory 232 such as volatile memory 112 described with respect to FIG. 1. SAT video server 230 includes, in memory 232, SAT manager module 234 having functionality in embodiments to manage OTT advertising to a user's client VS player, SAT ads selector module 236 having functionality to select ads targeted to the user, SAT ads inserter module 238 having functionality to insert ads selected for the user into the video streaming to the user's SAT client device, and video stream feeder module 240 having functionality to encode the video and stream the video data to the video stream player on the user's SAT client device.

In embodiments, SAT manager module 210 includes functionality to manage OTT advertising and may receive the optimal advertisement interval to show ads inserted into the video stream sent by the SAT client 206. For instance, in the example of the user's activities of watching the video stream and making coffee in which the SAT calculator module 222 determined an optimal advertisement interval of ten (10) minutes, an optimal advertisement interval of (42′34″, 52′34″) may be received in embodiments which represents the tuple (t1, t2), where t1 is the start time and t2 is the end time of the optimal advertisement interval in minutes and seconds, respectively. The SAT manager module 234 may send a request to the SAT ads selector module 236 to select ads for the user for this optimal advertisement interval.

In embodiments, SAT ads selector module 236 includes functionality to select ads for the user for the optimal advertisement interval. To do so, the SAT ads selector module 236 may select ads targeted for the user in embodiments based on the user profile including demographic information, purchasing behaviors, browsing interests, and other marketing information. In the example of the user's activities of watching the video stream and making coffee in which the SAT calculator module 222 determined an optimal advertisement interval of ten (10) minutes, the SAT ads selector module 236 may for instance select a sequence of ten (10) one-minute ads targeted for the user. The SAT ads selector module 236 sends the sequence of the selected ads to the SAT manager module 234 which sends a request to the SAT ads inserter module 238 to insert the sequence of ads at the optimal advertisement interval.

In embodiments, SAT ads inserter module 238 includes functionality to insert ads selected for the user into the video streaming to the user's SAT client device at the optimal advertisement interval. In the example of the user's activities of watching the video stream and making coffee in which the SAT calculator module 222 determined an optimal advertisement interval of ten (10) minutes, the SAT ads inserter module 238 inserts the sequence of ten (10) one-minute ads selected by the SAT ads selector module 236 and the video stream feeder module 240 streams the ads to the video stream player on the user's SAT client device.

In embodiments, SAT manager module 234, SAT ads selector module 236, SAT ads inserter module 238, and video stream feeder module 240, each may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The SAT video server 230 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the present invention, FIG. 2 also shows a block diagram of storage 242 which may be storage such as storage 124 of computer 101 described with respect to FIG. 1. Storage 242 may store service profile 244 in files which may include control and configuration information for streaming video over a network, user profile 246 in files which may include demographic information, purchasing behaviors, browsing interests, and other marketing information useful for targeted advertising, SAT criteria 248 in files which may include criteria for ad insertion, and SAT data 250 in files which may include operational information such as timeline information, SAT user identifier, video ID, activities, attention point data, predicted activities, advertisement tolerance levels, optimal advertisement intervals, and Ad IDs.

Storage 242 may also store VS repository 252 that includes video streaming files, VS 253, and ads repository 254 that includes streaming ads files, Ad 255. Each of the video streaming files and the streaming ads files may include file descriptions such as file name, file format type (i.e. MPEG-4), file playing duration, and so forth. The video stream feeder module 240 of the SAT video server 230 encodes the video streaming files and the streaming ads files and streams the video data to the VS player 224 on the user's SAT client device 206.

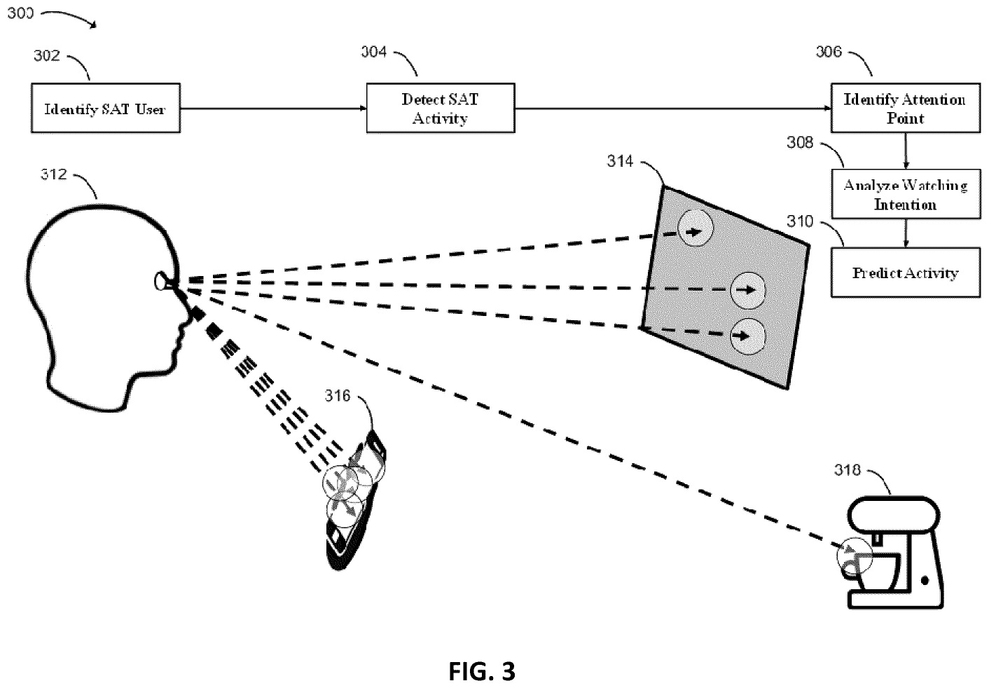

FIG. 3 depicts an illustration of an exemplary process flow in a depiction of an exemplary physical environment in accordance with aspects of the present invention. In particular, the diagram of FIG. 3 illustrates the process flow environment 300 in embodiments to manage and control the advertisement insertion time and advertisement length based on user activities detected by IoT sensors. At reference numeral 302, the system identifies the user of a client device watching a streaming video. For instance, the system provides an identifier of the user 312 watching the streaming video playing on smart TV 314.

As the user 312 watches the streaming video playing on smart TV 314, the system detects user activity at 304. For instance, smart TV 314 includes a camera and eye gazing and/or eye tracking functionality that detects the user is watching the screen of smart TV 314. The system receives the information of eye gazing and/or eye tracking that indicates the user is watching the video stream. The user 312 may turn attention to the user's smart phone 316 that also includes a camera and eye gazing and/or eye tracking functionality that detects the user 312 is watching the screen of smart phone 316. The system may also receive information of applications in use by the user from the user's smart phone 316 such as an email application, an application controlling a coffee maker 318, an Internet browser, or other applications. The system may further receive information from IoT sensors of smart appliances of activities such as information from a proximity sensor of the opening and closing of the user's refrigerator door (not shown). Those skilled in the art should appreciate that other IoT sensors may provide information of the user's activities including wearable IoT sensors such as wireless insole pressure sensors and accelerometer sensors that transmit information of the user's motion, among other IoT sensors.

At reference numeral 306, the system receives information to identify the attention point of the user from IoT sensors such as a camera. For instance, smart TV 314 equipped in embodiments with a camera that includes eye gazing and/or eye tracking functionality detects the attention point of the user's visual attention on the screen. The system may receive information of 60 to 300 attention points per minute in embodiments that may be analyzed to understand the level of visual attention of the user 312 watching the video stream. Accordingly, the system analyzes the watching attention of the user at 308 to determine the likelihood the user intends to continue watching the video stream based on the number of attention points of the user on the screen of smart TV 314 detected by the camera. The higher the number of attention points of the user on the screen over the time period indicates the greater visual attention of the user watching the video stream and the greater the likelihood the user intends to continue watching the video stream. The system provides a watching intention likelihood from the analysis that the user intends to continue watching the video stream.

At reference numeral 310 the system predicts the next activity of the user 312 based on the watching intention likelihood and previous activities. The systems analyzes the previous activities of the user, such as watching the video stream, sleeping, making coffee, opening the refrigerator door, interacting with email, among other activities, and the watching intention likelihood and predicts the next activity of the user. For instance, the system may receive the activity of watching the video steam and the watching intention likelihood of 90 percent and predict the next activity of the user will be watching the video stream. As another example, the system may receive the activities of watching the video steam and opening an email application and the watching intention likelihood of 50 percent and predict the next activity of the user will be checking email. The system can accordingly use the predicted activity to determine an optimal advertisement interval to interrupt the video streaming and insert ads into the video stream.

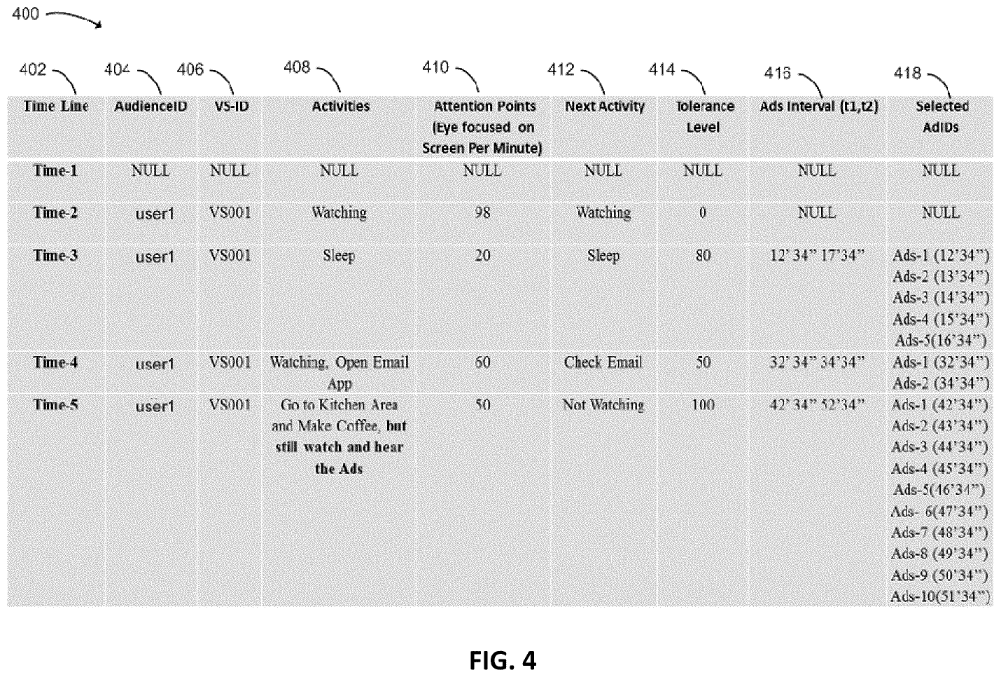

FIG. 4 depicts an illustration of an exemplary data table in accordance with aspects of the present invention. In particular, the exemplary data table stores values determined by the system to derive the optimal advertisement interval for the advertisement insertion time and advertisement length of streaming ads based on user activities detected by IoT sensors. At reference numeral 402, the exemplary data table 400 includes a column labeled “Timeline” of time periods such as time-1, time-2, time-3, time-4 and time-5. In embodiments, the time period may be one-minute intervals, for example, during which the system determines values for each of the time periods in data table 400. Those skilled in the art should appreciate that other time periods of shorter or longer intervals may be used such thirty-second intervals or five-minute intervals. At reference numeral 404, data table 400 includes a column labeled “AudienceID” of SAT user identifiers and a column labeled “VS-ID” of VS identifiers at reference numeral 406.

At reference numeral 408, data table 400 includes a column labeled “Activities” of activities detected by IoT sensors. For instance, the activities shown include “watching.” “sleep,” “open email app.” “make coffee,” among others. The system may also receive information of activities such as applications in use by the user, for instance, from the user's smart phone including an email application, an Internet browser, or other applications. The system may further receive information from IoT sensors of smart appliances of activities such as the opening and closing of the user's refrigerator door. Importantly, the activities are not limited to what is shown in FIG. 4 and, in practice, the activities may be any activity for which an IoT sensor may provide information, including wearable IoT sensors such as wireless insole pressure sensors and accelerometer sensors that transmit information of the user's motion, among other IoT sensors.

At reference numeral 410, data table 400 includes a column labeled “Attention Points” of counts of the number of attention points of the user on the screen displaying the streaming video detected for the time period of one minute. Generally, the system may receive information of 60 to 300 attention points per minute in embodiments that may be analyzed to understand the level of visual attention of the user watching the video stream. The higher the number of attention points of the user on the screen over the time period indicates the greater visual attention of the user watching the video stream and the greater the likelihood the user intends to continue watching the video stream. Accordingly, the system analyzes the counts of the number of attention points of the user as one indicator to determine the likelihood the user intends to continue watching the video stream.

At reference numeral 412, data table 400 includes a column labeled “Next Activity” of activities predicted as the next activities of the user in the time period. The system receives the activities of the user watching the video stream detected by various IoT sensors, such as watching the video stream, sleeping, making coffee, opening the refrigerator door, interacting with email, among other activities, and the likelihood the user intends to continue watching the video stream and predicts the activities of one or more upcoming time periods. For example, the system may receive the activity of watching the video stream and a likelihood of 90 percent that the user intends to continue watching the video stream and predicts the next activity of the user to be watching the video stream. As another example, the system may receive the activities of watching the video steam and opening an email application and a likelihood of 50 percent that that the user intends to continue watching the video stream and predicts the next activity of the user to be checking email. The predicted activity may be used among other information to determine the advertisement tolerance level of the user for interrupting streaming the content of the video to show ads inserted into the video stream in embodiments.

At reference numeral 414, data table 400 includes a column labeled “Advertisement tolerance level” of percentages that the user would tolerate interrupting streaming the content of the video to show ads. The advertisement tolerance level is represented as a percentage on a scale of 0 to 100. High percentages of the advertisement tolerance level indicate more optimal opportunities to interrupt streaming the content of the video to show ads. For example, the advertisement tolerance levels of 80 percent and 100 percent shown in the column at 414 of data table 400 are optimal opportunities to interrupt streaming the content of the video to show ads. In the case of the advertisement tolerance level of 80 percent, the next activity predicted by the user is “sleeping,” and, in the case of the advertisement tolerance level of 100 percent, the next activity predicted by the user is “not watching.” The system uses the information of the advertisement tolerance level for upcoming time periods to determine the optimal advertisement interval for showing ads inserted into the video stream.

At reference numeral 416, data table 400 includes a column labeled “Ads Interval (t1,t2)” of optimal advertisement intervals for interrupting streaming the content of the video to show ads. The optimal advertisement interval for showing ads inserted into the video stream may be represented as a tuple of a start time, t1, and an end time, t2, such as (t1, t2) in embodiments. At the time period, Time-5, the ad interval in data table 400 is (42′34″, 52′34″) indicating a 10-minute interval starting 42 minutes and 34 seconds from the beginning of the streaming video in which ads may be inserted. In the case of the time period Time-5, the system predicts the activity of the user to be not watching the video stream for the next ten (10) upcoming time periods while the user is taking a coffee break and determines an optimal advertisement interval of ten (10) minutes.

At reference numeral 418, data table 400 includes a column labeled “Selected AdIDs” of ad IDs selected for insertion in the streaming video during the ad interval. At the time period, Time-5, ten (10) one-minute ads, labeled Ads-1 to Ads-10, are selected in data table 400 for insertion during ad interval (42′34″, 52′34″) which the system determined from the prediction that the user's activity will be not watching the video stream for the next ten (10) one-minute time periods while the user is taking a coffee break. Data table 400 recording values determined by the system to derive the optimal advertisement interval for the advertisement insertion time and advertisement length of streaming ads may be stored as SAT data 250 in storage 242 of SAT video server 230 described with respect to FIG. 2.

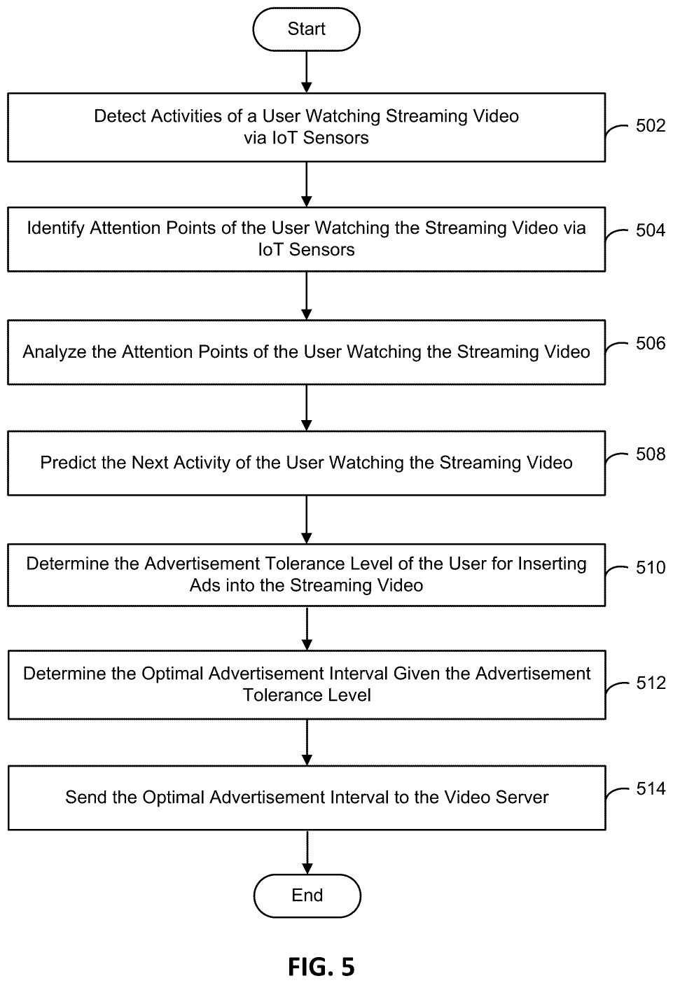

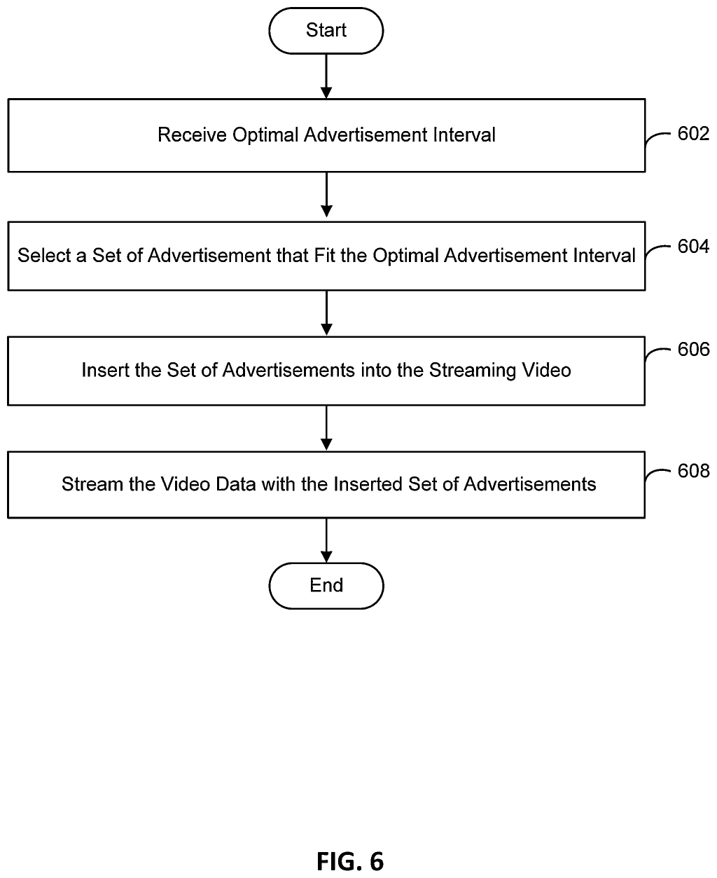

FIGS. 5-6 show flowcharts and/or block diagrams that illustrate the architecture, functionality, and operation of possible implementations of systems, methods, and computer program products according to various embodiments of the present invention. As noted above with respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time. And some blocks shown may be performed and other blocks not performed, depending upon the functionality involved.

FIG. 5 shows a flowchart of an exemplary method in accordance with aspects of the present invention. Steps of the method may be carried out in the environment of FIG. 2 and are described with reference to elements depicted in FIG. 2. In particular, the flowchart of FIG. 5 shows an exemplary method for deriving the optimal advertisement interval for streaming ads during video streaming based on user activities detected by IoT sensors in accordance with aspects of the present invention.

At step 502, the system detects activities of a user watching a streaming video via IoT sensors in response to receiving an opt-in from the user. For example, an IoT sensor such as a camera integrated in a smart TV that includes eye gazing and/or eye tracking functionality can detect the user watching the screen of the smart TV streaming video, sleeping, or not paying visual attention to the screen, for instance, by looking away from the screen. The system may receive information of eye gazing and/or eye tracking of the user watching the screen of the smart TV, sleeping, or not paying visual attention to the screen. As another example, an IoT sensor such as a camera integrated in the user's smart phone that includes eye gazing and/or eye tracking functionality can detect the user watching the screen of the smart phone. The system may receive information of eye gazing and/or eye tracking of the user watching the screen of the smart phone as well as information of applications in use by the user from the user's smart phone such as an email application, an application controlling a coffee maker, an Internet browser, or other applications. As a further example, an IoT sensor such as a proximity sensor integrated in the user's appliance such as a refrigerator can detect the opening and closing of the appliance door. Those skilled in the art should appreciate that other IoT sensors may provide information of the user's activities to the system including wearable IoT sensors such as a wireless insole pressure sensor and an accelerometer sensor that transmit information of the user's motion, among other IoT sensors. In embodiments, and as described with respect to FIG. 2, SAT activity detector module 212 detects activities of the user watching the streaming video via IoT sensors.

At step 504, the system identifies attention points of the user watching the streaming video via IoT sensors. For example, the system receives information to identify the attention points of the user from IoT sensors such as a camera. For instance, a smart TV in embodiments with the camera that includes eye gazing and/or eye tracking functionality can detect the attention point of the user's visual attention on the screen. The system may receive information of 60 to 300 attention points per minute in embodiments that may be analyzed to understand the level of visual attention of the user watching the video stream. In embodiments, and as described with respect to FIG. 2, attention point identifier module 214 identifies attention points of the user watching the streaming video via IoT sensors.

At step 506, the system analyzes the attention points of the user watching the streaming video. For example, the system receives the number of attention points of the user detected on the screen for a time period, for instance a one-minute interval, and determines the likelihood that the user intends to continue watching the video stream. The higher the number of attention points of the user on the screen over the time period indicates greater visual attention of the user watching the video stream and the greater the likelihood the user intends to continue watching the video stream. In embodiments, and as described with respect to FIG. 2, watching intention analyzer module 216 analyzes the attention points of the user watching the streaming video.

At step 508, the system predicts the next activity of the user watching the streaming video. For example, the system analyzes the previous activities of the user, such as watching the video stream, sleeping, making coffee, opening the refrigerator door, interacting with email, among other activities, and the watching intention likelihood and predicts the next activity of the user. For instance, the system may receive the activity of watching the video steam and the watching intention likelihood of 90 percent and predict the next activity of the user will be watching the video stream. As another example, the system may receive the activities of watching the video steam and opening an email application and the watching intention likelihood of 50 percent and predict the next activity of the user will be checking email. In embodiments, and as described with respect to FIG. 2, activity predictor module 218 predicts the next activity of the user watching the streaming video.

At step 510, the system determines the advertisement tolerance level of the user for inserting ads into the video stream. For example, the system receives the activities of the user watching the video stream detected by various IoT sensors and the watching intention likelihood that the user intends to continue watching the video stream in embodiments and determines the advertisement tolerance level of the user for inserting ads into the video stream. The advertisement tolerance level may be represented as a percentage on a scale of 0 to 100 for a certain time period in embodiments. Those skilled in the art should appreciate that the system may determine the advertisement tolerance level of the user based on the activities of the user watching the video stream detected by various IoT sensors and/or the watching intention likelihood that the user intends to continue watching the video stream and/or the predicted next activity of the user. For instance, the system may receive the activity of watching the video steam and the watching intention likelihood of 90 percent as well as the predicted next activity of the user to be watching the video stream and determine the advertisement tolerance level for interrupting streaming the content of the video to insert ads to be 10 percent. The advertisement tolerance level may be used among other information in embodiments to determine the optimal advertisement interval to show ads inserted into the video stream. In embodiments, and as described with respect to FIG. 2, ads tolerance wizard module 220 determines the advertisement tolerance level of the user for inserting ads into the video stream.

At step 512, the system determines the optimal advertisement interval given the advertisement tolerance level. For instance, the system receives the information of the advertisement tolerance level and determines the optimal advertisement interval for showing ads inserted into the video stream. The optimal advertisement interval for showing ads inserted into the video stream may be represented as a tuple of a start time, t1, and an end time, t2, such as (t1, t2) in embodiments. For example, the system may receive information of the advertisement tolerance level of 100 for the next ten (10) upcoming one-minute time periods in embodiments and determine an optimal advertisement interval of ten (10) minutes beginning at the start of the next upcoming time period and ending at the end of the tenth (10th) upcoming time period. In addition to the information of the advertisement tolerance level for upcoming time periods, those skilled in the art should appreciate that the system may also include functionality to receive in embodiments the activities of the user watching the video stream detected by various IoT sensors, the watching intention likelihood for a predetermined number of previous time periods, and the predicted activities of certain upcoming time periods for use in determining the optimal advertisement interval. In embodiments, and as described with respect to FIG. 2, SAT calculator module 222 determines the optimal advertisement interval given the advertisement tolerance level.

At step 514, the system sends the optimal advertisement interval to the video server. In embodiments, and as described with respect to FIG. 2, SAT client 206 sends the optimal advertisement interval to the SAT video server 230. In this way, the SAT client 206 can derive the optimal advertisement interval for streaming ads during video streaming based on user activities detected by IoT sensors in accordance with aspects of the present invention. The SAT video server 230 inserts streaming ads into the video streaming file at the optimal advertisement interval, encodes the video streaming files with the inserted streaming ads files, and streams the video data to The SAT client 206. The SAT client receives the streaming video data, decodes the video data into the video streaming files with inserted streaming ads files and the VS player 224 plays the streaming video on the user's SAT client device 206 in embodiments.

FIG. 6 shows a flowchart of an exemplary method in accordance with aspects of the present invention. Steps of the method may be carried out in the environment of FIG. 2 and are described with reference to elements depicted in FIG. 2. In particular, the flowchart of FIG. 6 shows an exemplary method for selecting and inserting streaming ads in a video stream for an optimal advertisement interval based on user activities detected by IoT sensors in accordance with aspects of the present invention.

At step 602, the system receives the optimal advertisement interval for a user watching a streaming video. For example, the system may receive the optimal advertisement interval to show ads and may select ads for the user that fit within the received optimal advertisement interval. In embodiments, SAT video server 230 receives the optimal advertisement interval for the user watching the streaming video.

At step 604, the system selects a set of advertisements that fit within the optimal advertisement interval. For example, the system may select ads targeted for the user in embodiments based on the user profile including demographic information, purchasing behaviors, browsing interests, and other marketing information. For an optimal advertisement interval of ten (10) minutes, the system may for instance select a sequence of ten (10) one-minute ads targeted for the user. In embodiments, SAT ads selector module 236 selects a set of advertisements that fit within the optimal advertisement interval.

At step 606, the system inserts the set of advertisements into the streaming video. For an optimal advertisement interval of ten (10) minutes specified for example by the tuple, (42′34″, 52′34″), the system inserts the set of advertisements for the ten (10) minute period starting 42 minutes and 34 seconds from the beginning of the streaming video. In embodiments, and as described with respect to FIG. 2, SAT ads inserter module 238 inserts the set of advertisements into the streaming video.

At step 608, the system streams the video data with the inserted set of advertisements during the optimal advertisement interval. In embodiments, and as described with respect to FIG. 2, video stream feeder module 240 streams the video data with the inserted set of advertisements during the optimal advertisement interval. More particularly, and as described with respect to FIG. 2, video stream feeder module 240 of the SAT video server 230 encodes the video streaming files and the streaming ads files and streams the video data to the VS player 224 on the user's SAT client device 206 in embodiments. Accordingly, the system selects and inserts streaming ads in a video stream for an optimal advertisement interval based on user activities detected by IoT sensors in accordance with aspects of the present invention.

In this way, embodiments of the present invention dynamically maximize advertisement time in streaming video based on audience tolerance in real time. Furthermore, embodiments of the present invention manage and control the advertisement insertion time and advertisement length based on user activities detected by IoT sensors.

Those skilled in the art should appreciate that the methods, systems, and computer program products described herein can be enhanced to provide a distributed ledger blockchain with geographical localization of generic RPA scripts and RPA analytics of interaction patterns. For example, the system can identify in embodiments the geographical location of the client device used by a developer and automatically compare it to the location of the client devices used by other developers. The system can accordingly standardize the RPA scripts and interaction patterns based on the geographical location of the user.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a processor set, an opt-in from a user;
in response to the opt-in, detecting, by the processor set and via an Internet of Things (IoT) sensor, activities of the user watching a streaming video on a client device;
determining, by the processor set, an advertisement tolerance level of the user based on the detected activities of the user watching the streaming video;
determining, by the processor set, an optimal advertisement interval in the streaming video based on the advertisement tolerance level of the user; and
streaming, by the processor set, advertisements during the optimal advertising interval in the streaming video on the client device.

2. The method of claim 1, further comprising identifying, by the processor set, attention points of the user on the screen of the client device.

3. The method of claim 1, further comprising analyzing, by the processor set, attention points of the user on the screen of the client device.

4. The method of claim 1, further comprising predicting, by the processor set, a next activity of the user watching the streaming video based on the activities.

5. The method of claim 1, further comprising sending, by the processor set, the optimal advertising interval to a video server.

6. The method of claim 1, further comprising receiving, by the processor set and from a video server, the streaming advertisements during the optimal advertising interval in the streaming video on the client device.

7. The method of claim 1, further comprising determining, by the processor set, a likelihood that the user intends to continue watching the streaming video.

8. The method of claim 1, further comprising storing, by the processor set, the detected activities, advertisement tolerance level, and optimal advertisement interval in persistent storage.

9. The method of claim 1, wherein the determining the advertisement tolerance level comprises determining the advertisement tolerance level of the user based on the activities detected and a likelihood that the user intends to continue watching the streaming video.

10. The method of claim 1, wherein the determining the advertisement tolerance level comprises determining the advertisement tolerance level of the user based on the activities detected and a predicted next activity.

11. The method of claim 1, wherein the determining the advertisement tolerance level comprises determining the advertisement tolerance level of the user based on the activities detected and an analysis of attention points of the user on a screen of the client device.

12. The method of claim 1, wherein the IoT sensor comprises a camera integrated in the client device.

13. A computer program product comprising one or more computer readable storage media having program instructions collectively stored on the one or more computer readable storage media, the program instructions executable to:
receive an opt-in from a user;
in response to the opt-in, detect, via an Internet of Things (IoT) sensor, activities of the user watching a streaming video on a client device;
analyze attention points of the user on a screen of the client device;
determine an advertisement tolerance level of the user based on the analysis of the attention points of the user on the screen of the client device;
determine an optimal advertisement interval in the streaming video based on the advertisement tolerance level of the user; and
stream advertisements during the optimal advertising interval in the streaming video on the client device.

14. The computer program product of claim 13, wherein the program instructions are further executable to identify the attention points of the user on the screen of the client device.

15. The computer program product of claim 13, wherein the program instructions are further executable to determine a likelihood that the user intends to continue watching the streaming video.

16. The computer program product of claim 13, wherein the program instructions to determine the advertisement tolerance level comprises program instructions to determine the advertisement tolerance level of the user based on the analysis of the attention points of the user on the screen of the client device and the detected activities.

17. A system comprising:
a processor set, a computer readable memory, one or more computer readable storage media, and program instructions collectively stored on the one or more computer readable storage media, the program instructions executable to:
receive an opt-in from a user;
in response to the opt-in, detect activities of the user watching a streaming video on a client device via at least one Internet of Things (IoT) sensor;
predict a next activity of the user watching the streaming video based on the activities;
determine an advertisement tolerance level of the user based on the predicted next activity of the user watching the streaming video;
determine an optimal advertisement interval in the streaming video based on the advertisement tolerance level of the user; and
stream advertisements during the optimal advertising interval in the streaming video on the client device.

18. The system of claim 17, wherein the program instructions are further executable to analyze attention points of the user on the screen of the client device.

19. The system of claim 17, wherein the program instructions are further executable to determine a likelihood that the user intends to continue watching the streaming video.

20. The system of claim 17, wherein the program instructions to determine the advertisement tolerance level comprises determining the advertisement tolerance level of the user based on the predicted next activity and the activities detected by the at least one IoT sensor.
